(19) United States
(12) Patent Application Publication
(10) Pub. No.: US 2010/0148542 A1
(43) Pub. Date: Jun. 17, 2010

(54) MULTI-PURPOSE CHAIR

(76) Inventor: Arnold Zidulka, Montreal (CA)

Correspondence Address: OGILVY RENAULT LLP, 1, Place Ville Marie, SUITE 2500, MONTREAL, QC, H3B 1R1, CA

(21) Appl. No.: 12/448,370

(22) PCT Filed: Dec. 18, 2007
(86) PCT No.: PCT/CA2007/002305

§ 371 Date: Nov. 12, 2009

Related U.S. Application Data
(60) Provisional application No. 60/875,390, filed on Dec. 18, 2006.

(51) Int. Cl. A47C 3/20; A47C 1/00; A61G 7/10; A47B 83/02

(52) U.S. Cl. 297/174 R; 297/344.1; 5/85.1; 297/344.12

(57) ABSTRACT

A patient supporting chair comprising a seat assembly for supporting the seated patient mounted to a displaceable frame, the seat assembly being removably and rotationally engaged to the frame by two laterally spaced apart side swivel members. The swivel members pivotally engage opposed sides of a front end of the seat portion to corresponding mounting points on the frame such that the seat assembly is selectively pivotable relative to the frame about a substantially vertical pivot axis located at each of the two side swivel members. Each swivel member includes a locking mechanism displaceable between a locked position and an open position. The seat assembly is pivotable about the pivot axis of one of the two swivel members when the locking mechanism of this one of the two swivel members is disposed in the locked position and the other of the two swivel members is disposed in the open position.

### CROSS-REFERENCE TO RELATED APPLICATIONS

This is a national phase entry of International Patent Application No. PCT/CA2007/002305 filed on Dec. 18, 2007, designating the United States, which itself claims priority on U.S. Provisional Application No. 60/875,390 filed on Dec. 18, 2006, both of which are incorporated by reference herein.

### FIELD OF THE INVENTION

The present invention relates to a device used for patient care, and more particularly to a multi-purpose chair for supporting a patient on a bed, allowing transport of the patient, and facilitating routine personal needs of the patient.

### BACKGROUND ART

Most patient care is administered bedside and, although medical technology is highly evolved, the routine, practical, logistical imperatives confronted by nurses and other care givers have been largely ignored.

For respiratory patients it is important for them to assume a characteristic sitting position which makes breathing easier, that is, leaning forward with elbows partially supporting the weight of the upper body, without obliging hospital staff to transfer them to an independent chair. Sitting semi-upright in a hospital bed with one's legs outstretched is not an optimal position for respiratory function in patients who are already short of breath, nor is it optimal for bowel movements.

Equipment facilitating the transport of patients must ideally be easy to use such as to facilitate the task of the caregiver. The equipment must also allow the caregiver to move a patient lacking in mobility with minimal effort in order to prevent work related injury such as back injury.

Accordingly, improvements are desirable.

### SUMMARY OF INVENTION

It is therefore an aim of the present invention to provide an improved chair

Therefore, in accordance with an aspect of the present invention, there is provided a chair for supporting a patient, the chair comprising: a frame having a displaceable base and a seat support member; a seat assembly for supporting a seated patient, the seat assembly having a seat portion including a removable seat plate and a backrest portion extending upwardly from the seat portion at a rear end thereof; the seat assembly being removably and rotationally engaged to the seat support member of the frame by two laterally spaced apart side swivel members permitting the seat assembly to selectively pivot relative to the frame about a substantially vertical pivot axis located at each of the two side swivel members, the swivel members engaging opposed sides of a front end of the seat portion to corresponding mounting points on the frame; and wherein each swivel member includes a protruding locking member normally positioned in a closed position by a biasing member such as to engage the seat assembly to the frame, the locking member of the two swivel members being collapsible under a force acting against that of the biasing member to displace the locking member into an open position such that the seat assembly is pivotable relative to the frame, wherein the seat assembly is pivotable about the substantially vertical pivot axis of one of the swivel members having the locking member in the closed position when the locking member of the other of the swivel members is disposed in the open position.

There is also provided, in accordance with another aspect of the present invention, a chair for supporting a patient, the chair comprising: a frame having a displaceable base and a seat support member; a seat assembly for supporting a seated patient, the seat assembly having a seat portion including a removable seat plate and a backrest portion extending upwardly from the seat portion at a rear end thereof; the seat assembly being removably and rotationally engaged to the seat support member of the frame by two laterally spaced apart side swivel members, the swivel members pivotally engaging opposed sides of a front end of the seat portion to corresponding mounting points on the frame such that the seat assembly is selectively pivotable relative to the frame about a substantially vertical pivot axis located at each of the two side swivel members; and wherein each said swivel member includes a locking mechanism displaceable between a locked position and an open position, the locking mechanism being biased in the locked position until manually actuated into the open position, the seat assembly being pivotable about the substantially vertical pivot axis of one of the two swivel members when the locking mechanism of said one of the two swivel members is disposed in the locked position and the other of the two swivel members is disposed in the open position.

There is further provided, in accordance with another aspect of the present invention, a chair for supporting a patient comprising: a frame having a displaceable base and a seat support member; a seat assembly for supporting the patient seated thereon, the seat assembly having a seat portion including a removable seat plate and a backrest portion extending upwardly from the seat portion at a rear end thereof, the seat assembly being removably and rotationally engaged to the seat support member of the frame by two laterally spaced apart side swivel members, the swivel members engaging opposed sides of a front end of the seat portion to corresponding mounting points on the seat support member of the frame, the swivel members permitting the seat assembly to selectively pivot relative to the frame about a substantially vertical pivot axis passing through each of the two side swivel members; and a lift assembly connected to the frame in front of the seat assembly, the lift assembly including a belt for surrounding a torso of the patient, the belt being supported by a remainder of the lift assembly such as to be movable to lift a patient partially surrounded by the seat assembly sufficiently to engage the seat plate with at least the lateral members.

In accordance with yet another aspect of the present invention, there is provided a chair comprising a base frame including a plurality of wheels, a central post having an adjustable length and extending upwardly from the base frame closer to a front end than to a rear end thereof, a support member connected at a top of the central post, the support member including two spaced apart side swivel members, a table assembly connected to the base frame frontwardly of the central post, and a seat assembly for surrounding a patient together with the table assembly, the seat assembly including two spaced apart lateral members interconnected by a rear member, a backrest extending upwardly from the rear member, an armrest extending over each lateral member, and a removable seat plate removably supported by at least the lateral members, a front end of each of the lateral members removably and rotationally engaging a respective one of the swivel members, wherein each swivel member includes a hollow member slidably receiving therein a locking member, the locking member protruding from the cylindrical member under the action of a spring, and the front end of each lateral member including a plate having a hole defined therethrough, the locking member being received in the hole of the respective plate for engaging the front end of the lateral member with the swivel member, the locking member being collapsible within the hollow member under the action of a force compressing the spring such that the plate and locking member are disengaged, the seat assembly being rotatable about one of the swivel members engaged with the respective plate when the other of the swivel members is disengaged from the respective plate.

### BRIEF DESCRIPTION OF THE DRAWINGS

Reference will now be made to the accompanying drawings, showing by way of illustration a particular embodiment of the present invention and in which:

FIG. 1 is a perspective view of a chair according to a particular embodiment of the present invention;

FIG. 2 is a perspective view of the chair of FIG. 1, further including a lift assembly;

FIG. 3 is a front view of a portion of the chair of FIGS. 1-2;

FIG. 4 is a side view of a portion of the chair of FIGS. 1-2;

FIG. 5 is a side view of a swivel element of the chair of FIGS. 1-2;

FIG. 6 is a side cross-sectional view of an upper section of the swivel element of FIG. 5 engaged with a portion of a seat assembly of the chair of FIGS. 1-2; and

FIG. 7 is a bottom cross-sectional view of the assembly of FIG. 6.

### DETAILED DESCRIPTION OF PARTICULAR EMBODIMENTS

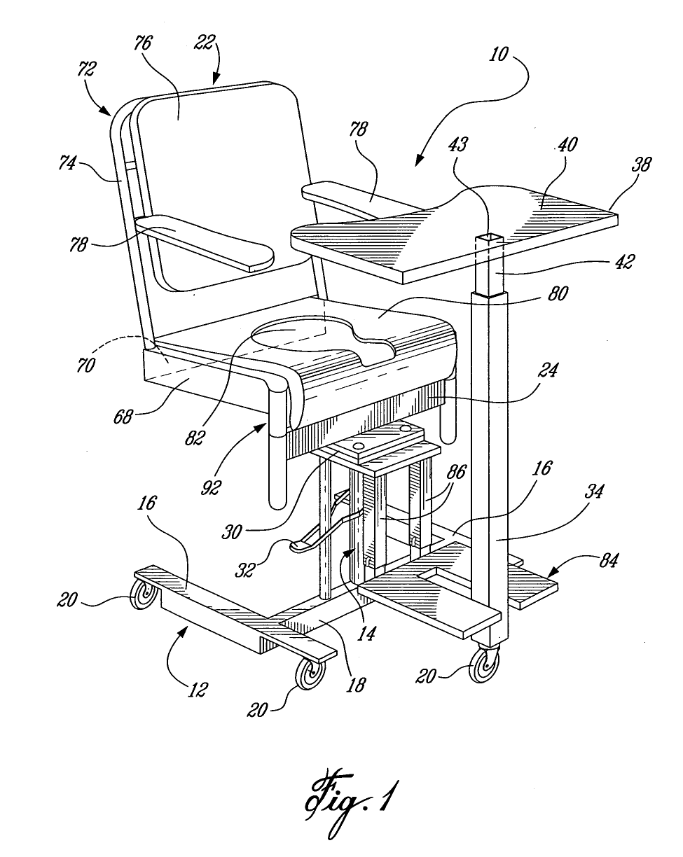

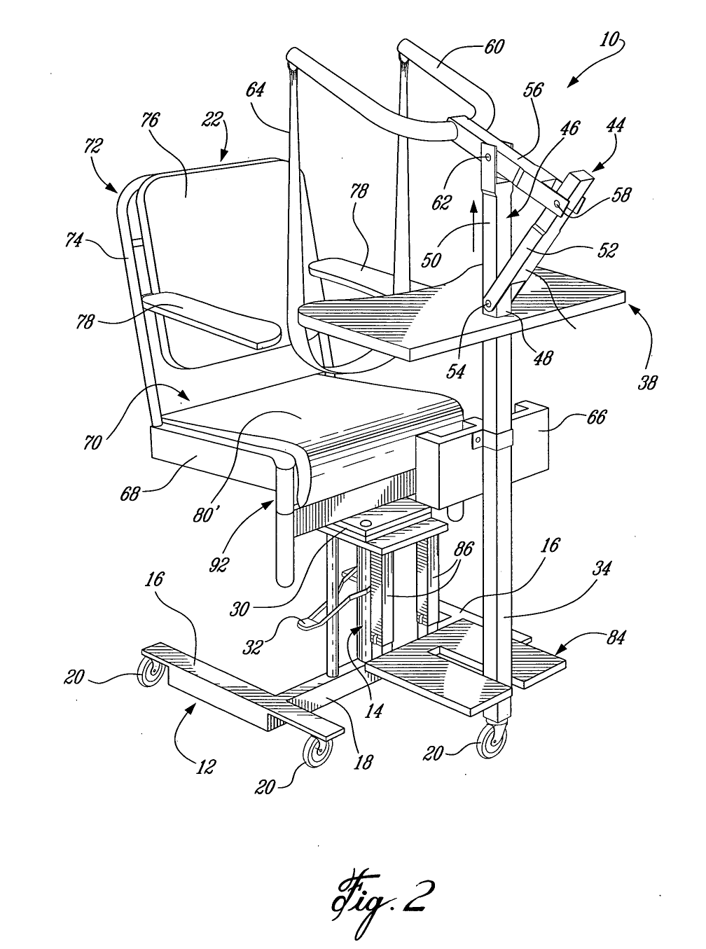

Referring to FIGS. 1-2, a chair according to a particular embodiment of the present invention is generally shown at 10. The chair 10 comprises a base frame 12 and a central seat post 14 extending therefrom. The base frame 12 includes two lateral members 16 interconnected by a central member 18, thus giving the base frame 12 an approximate H-shape, with the central member 18 being forwardly offset from a center of the lateral members 16. Each of the lateral members 16 includes wheels 20 on opposed ends thereof. The wheels 20 are preferably hospital style swivel-type casters so that the chair 10 may easily negotiate tight corners and confined spaces.

The base frame 12 is constructed so that at least a rear portion thereof is as close to the ground as possible in order to allow the base frame 12 to move under hospital beds. The chair 10 has as short a wheel base as possible without compromising overall vehicle stability. The front wheels 20 are preferably lockable.

In a particular embodiment, the lateral and central members 16, 18 are made of steel beams having a rectangular cross-section.

The central post 14 extends upwardly from the center of the central member 18. The central post 14 supports a cantilevered seat assembly 22 at its front by means of a transverse support beam 24 forming a T with the central post 14. The length of the central post 14 is adjustable such as to be able to adjust the height of the seat assembly 22 supported thereby.

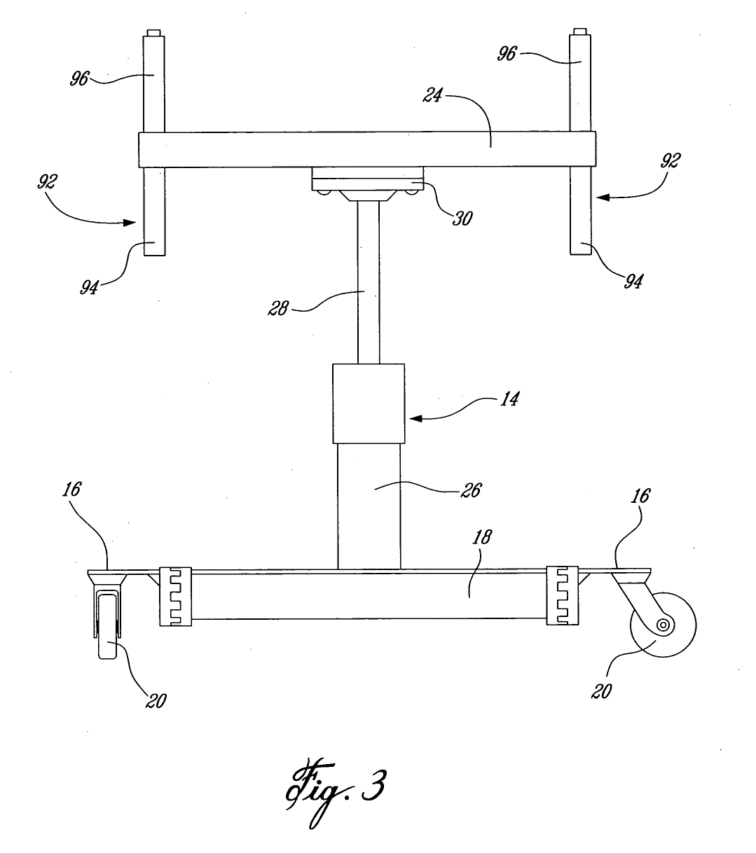

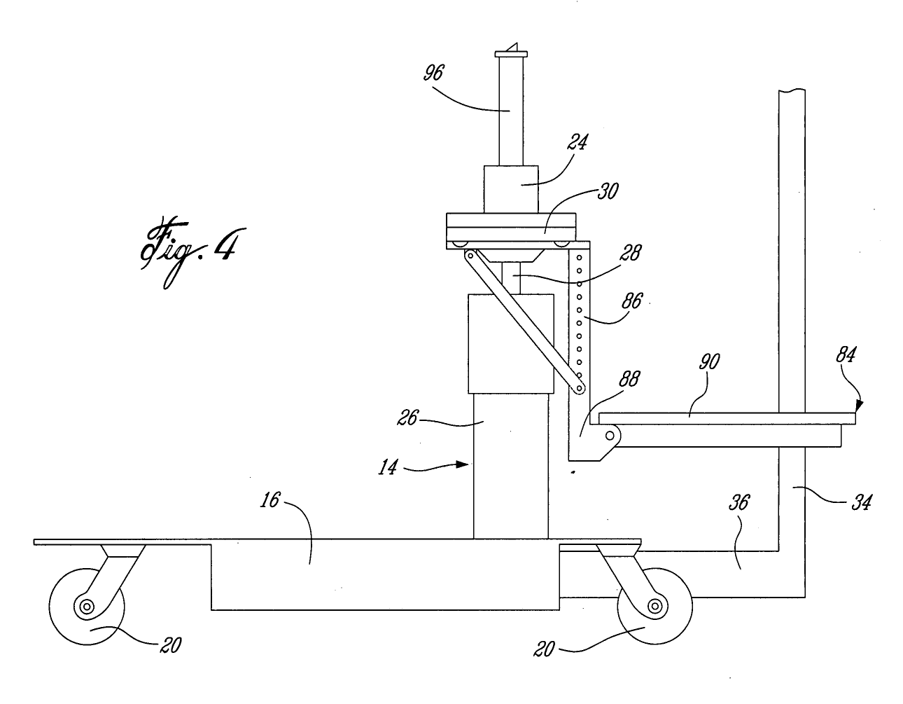

Referring to FIGS. 3-4, in a particular embodiment, the central post 14 is hydraulic and includes an outer cylinder 26 welded or otherwise attached to the central member 18, and a cylindrical tube 28 slidingly received within the outer cylinder 26. The top end of the cylindrical tube 28 is connected to a horizontal mounting plate 30, which is in turn connected to the transverse support beam 24. A hydraulic cylinder (not shown) is fixed and extends within the outer cylinder 26, and a piston (not shown) reciprocates in the hydraulic cylinder, the piston extending within the cylindrical tube 28 and being connected to the mounting plate 30. Oil is pumped within the hydraulic cylinder through the actuation of a foot pedal 32 (see FIGS. 1-2), to engage the piston and thus move the cylindrical tube 28 and the transverse support beam 24 upwardly. When it is required to lower the seat assembly 22, a valve (not shown) is operated to allow the oil to flow out of the hydraulic cylinder.

Alternately, the central post 14 can include any other means to adjust its length, such as for example an electric mechanism, or can have a fixed length.

Referring back to FIGS. 1-2, the chair 10 also includes a front post 34 extending vertically in front of the central member 18 and centered therewith, and connected thereto by an longitudinal member 36 (See FIG. 4) extending parallel or substantially parallel to the lateral members 16. The front post 34 also includes a wheel 20 at the bottom thereof.

Referring to FIG. 1, a table assembly 38 is removably supported by the front post 34. The table assembly 38 includes a table surface 40 and a table post 42 extending downwardly therefrom, which is slidably received within the front post 34 such that the height of the table surface 40 can be adjusted. The height of the table surface 40 is selectively locked using any type of appropriate locking member (not shown). For example, the table post 42 can be provided with a vertical line of apertures defined therethrough (not shown), in which a locking pin (not shown) provided in the front post 34 is engaged. The table post 42 is hollow and in connection with a hole 43 defined through the table surface 40, which is preferably selectively closed by a plug or another adequate closing member.

Referring to FIG. 2, a lift assembly 44 is removably received within the table post 42, through the hole 43 in the table surface 40. The lift assembly 44 includes a vertical lift post 46 received within the table post 43, and preferably also within the front post 34. In a particular embodiment the vertical lift post 46 is slidable within the table post 43 and front post 34 such that a height of the lift assembly 44 might be adjusted and locked at a desired position, although alternately the vertical lift post 46 can be received at a fixed height. The vertical lift post 46 includes a bottom section 48 and a top section 50 slidably attached thereto such as to vary the length of the vertical lift post 46, for example by having a tube of an actuator forming the bottom section 48 and a piston of the actuator forming the top section 50. The actuator can be actuated by any appropriate actuating member, such as for example a mechanical crank or a selectively actuated electric motor (not shown).

The lift assembly 44 also includes an angled front support bar 52 having a lower end engaged to the bottom section 48 of the vertical lift post 46 by a first pivot 54, and a top support bar 56 having a front end engaged to the upper end of the front support bar 52 by a second pivot 58. A U-shaped belt support member 60 is attached to a rear end of the top support bar 56, and the top support bar 56 is connected to the top section 50 of the vertical lift post 46 by a third pivot 62 located between the belt support member 60 and the second pivot 58. A belt 64 is attached to the belt support member 60 such as to form a closed loop therewith. Preferably, the belt 64 has an adjustable length and at least one end detachable from the belt support member 60 such as to facilitate use.

A kneepad 66 is also detachably received on the front post 34, the height of which can be adjusted.

Referring back to FIGS. 1-2, the seat assembly 22 includes lateral seat members 68 interconnected by a rear seat member 70, a backrest 72 extending from the rear seat member 70 which in the embodiment shown includes a tubular member structure 74 supporting a back cushion 76, and armrests 78 extending from the backrest 72. In a particular embodiment, the backrest 72 is attached to the rear seat member 70 such as to be reclined if desired. The armrests 78 are preferably upwardly pivotable to a vertical or substantially vertical position against or on each side of the backrest 72, and are preferably adjustable in height.

The seat assembly 22 also includes a seat plate 80, 80′ which is removably retained by the lateral and rear seat members 68, 70, such as for example by being slidably engaged in rails (not shown) of the lateral seat members 68. In a particular embodiment shown in FIG. 1, the seat plate 80 includes a central removable portion 82 so the seat plate 80 can serve as a toilet seat.

Referring to FIGS. 1-2, the chair 10 also includes a footrest 84 supported by vertical posts 86 extending downwardly from the mounting plate 30. Referring to FIG. 4, the footrest 84 preferably includes bottom posts 88 extending upwardly from a footrest platform 90 and slidably engaged with the vertical posts 86 such as to be able to adjust the height of the footrest platform 90.

Referring particularly to FIG. 3, a swivel member 92 is included on each extremity of the transverse support beam 24. Each swivel member 92 generally includes a locking mechanism which is displaceable between a locked position and an open position. The locking mechanism is, in at least one embodiment, biased in the locked position until manually actuated and or displaced into the open position thereof. The seat assembly is pivotable about a substantially vertical pivot axis passing through one of the two swivel members when the locking mechanism of this one of the two swivel members is disposed in the locked position and the other of the two swivel members is disposed in the open position. In the particular embodiment depicted, the locking mechanism of each of the swivel members includes a protruding locking member that is normally maintained in a mated position with an aperture in a corresponding part by a biasing member. The locking member is collapsible under a force acting against that of the biasing member to displace the locking member, such that the locking mechanism is disposed in the open position, thereby allowing that the seat assembly to pivot relative to the frame.

More specifically still, as shown and described in further detail below, the swivel members include a hollow member slidably receiving the locking member therein. The biasing member includes a spring forcing the locking member to protrude from the hollow member, and the front end of the seat portion including a plate having the aperture defined therethrough, the locking member being received in the aperture of the respective plate for engaging the front end of the seat portion with the frame such that the locking mechanism is in said locked position, and wherein the locking member is collapsible within the hollow member under the action of a force compressing the spring such that the plate and locking member are disengaged, thereby placing the locking mechanism is in said open position.

In the depicted embodiment, the swivel members 92 include a fixed lower section which is permanently attached to the transverse support beam 24 and protrudes downwardly therefrom, and a removable upper section 96 which is received within the lower section 94.

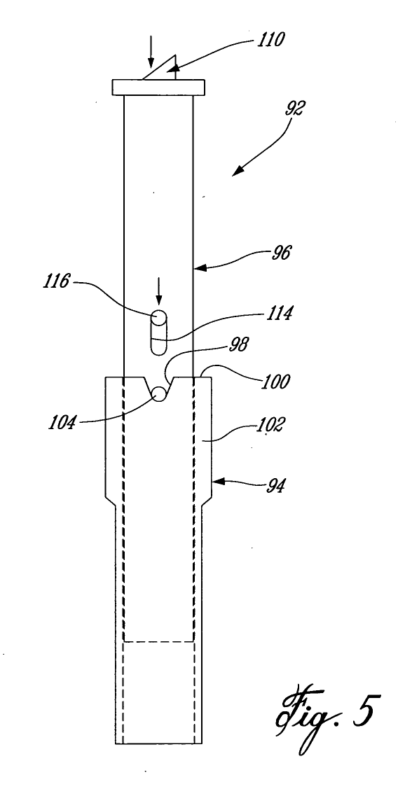

Referring to FIG. 5, the lower section 94 is a hollow cylindrical member having a slot 98 defined along a top border 100 thereof. In the embodiment shown the lower section 94 has an increased thickness 102 adjacent the top border 100 for improved mechanical resistance. Alternately, the lower section 94 can have a constant thickness throughout its length.

The upper section 96 is a cylindrical member sized to snuggly fit within the lower section 94. The upper section 96 includes a pin 104 protruding radially therefrom, which is received within the slot 98 of the lower section 94 such as to fix the relative position of the lower and upper sections 94, 96. The height of the pin 104 is selected such that the depth of the upper section 96 within the lower section 94 provides adequate stability.

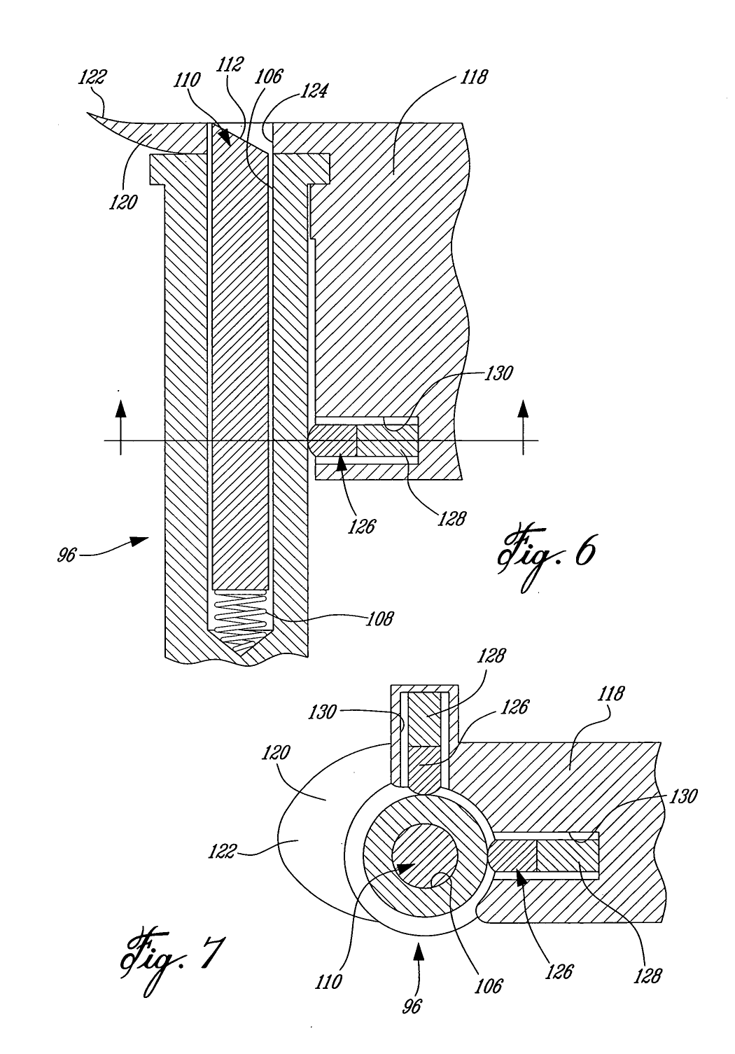

Referring to FIGS. 6-7, the upper section 96 includes a bore 106 defined in a center thereof and extending along only a top portion of the upper section 96. A spring 108 (not visible in FIG. 7) is received within the bore 106 at the bottom thereof, and a cylindrical locking member 110 is received within the bore 106 on top of the spring 108. The locking member 110 has a beveled top end 112 (not visible in FIG. 7) which, with the spring 108 in a minimally compressed state, e.g. compressed only by the weight of the locking member 110, protrudes upwardly from the bore 106. The length and stiffness of the spring 108 is selected such as to be able to move the locking member 110 downwardly to be completely contained within the bore 106, using reasonable force. Referring to FIG. 5, the upper section 96 includes an oblong slot 114 defined through a wall thereof, and the locking member 110 includes a pin 116 extending radially therefrom and protruding from the slot 114. The pin 116 is at its uppermost position within the slot 114 when the spring 108 is in the minimally compressed state and at its bottommost position when the locking member 110 is completely contained within the bore 106.

Referring back to FIGS. 6-7, the front end 118 of each lateral seat member 68 is cylindrical such as to conform to the upper section 96 and includes a rounded plate 120 extending substantially horizontally from the top thereof. The front edge 122 of the plate 120 is preferably curved upward such as to facilitate an interaction between the locking member 110 and the plate 120. The plate 120 has a hole 124 (see FIG. 6) defined therethrough receiving the top end 112 of the locking member 110 therein. The front end 118 of the lateral seat member 68 also includes pins 126 adjustably protruding therefrom and abutting the upper section 96 for improved stability. In a particular embodiment, each pin 126 includes a threaded portion 128 engaged in a threaded hole 130 of the lateral seat member 68. The beveled top end 112 of the locking member 110 is defined such as to extend progressively higher toward the front of the chair 10.

In use, the seat plate 80, 80′ is removed from the seat assembly 22. One of the locking members 110 is moved downwardly, by pressing down on its pin 116 within the slot 114 of the respective swivel member upper section 96, until the respective plate 120 is free of the locking member 110. The seat assembly 22 is then rotated to an open position (which can be for example approximately 180 degrees from its closed position corresponding to both plates 120 engaged with their respective locking member 110) about the plate 120 and locking member 110 that are still engaged to one another. Since a swivel member 92 is provided on each side of the seat assembly 22, the seat assembly 22 can alternately be opened from one side or the other. To facilitate moving the patient in place within the chair 10, the seat assembly 22 is preferably opened and rotated toward the head of the patient's bed.

In operation, the chair 10 is then moved up to the bed, with the rear portion of the base frame 12 extending under the bed and the central post 14 extending against the bed. The height of the seat assembly 22 is selected such as to allow the seat assembly 22 to rotate over the bed in close proximity thereto.

The patient is helped in a sitting position, with legs over the side of the bed and resting on the footrest platform 90, the height of which can be adjusted if necessary. The upper section 96 of the swivel member 92 free from the seat assembly 22 can be removed from the corresponding lower section 94 before the patient is moved, such as to facilitate the process of sitting the patient with his/her legs in proper position with respect to the base frame 12 of the chair 10. The seat assembly 22 is then rotated back around the patient and the plate 120 is re-engaged with the corresponding locking member 110, with contact between the beveled top end 112 of the locking member 110 and the upwardly curved front edge 122 of the plate 120 causing the locking member 110 to automatically move down within the upper section 96 as the seat assembly 22 is rotated in the closed position. When the hole 124 of the plate 120 becomes aligned with the locking member 110, the spring 108 pushes the locking member 110 up through the hole, effectively locking the seat assembly 22 on the transverse support beam 24. With the armrests 78 in their horizontal position and the table assembly 38 attached to the front post 34, the patient is safely retained in a sitting position directly on the bed and surrounded on all sides such as to prevent him/her from falling from the bed.

The seat assembly 22 can alternately be completely detached from the transverse support beam 24 (i.e. instead of rotating about one engaged end), and reattached when the patient is in position with respect to the base frame 12.

If the patient needs to be moved, the seat plate 80, 80′ is engaged with the seat members 68, 70. If the patient is strong enough, he/she grabs the front of the table surface 40, with or without the help of the kneepad 66 shown in FIG. 2 for blocking his/her knees, and leans forward such as to lift his/her posterior off the bed. The seat plate 80, 80′ is then slid in place in engagement with the seat members 68, 70 from behind, and the patient sits down on the seat plate 80, 80′. Otherwise, the hole 43 in the table surface 40 is unplugged and the lift assembly 44 is slid therethrough. The lift assembly 44 is used to lift the patient's posterior off the bed, by increasing the length of the vertical lift post 46 with the belt 64 surrounding the patient's torso and the patient's knees resting against the kneepad 66. Once the patient is lifted, the seat plate 80, 80′ is slid in engagement with the seat members 68, 70 from behind, and the patient in then lowered on the seat plate 80, 80′ and set free of the lift assembly 44. The lift assembly 44 is then removed, and the hole 43 in the table surface 40 is preferably closed.

Alternately, the table assembly 38 can be removed before the installation of the lift assembly 44.

With the patient in a seated position on the seat plate 80, 80′, the chair 10 can be wheeled off the bed and used as a wheelchair, with the height of the seat assembly 22 being preferably adjusted such as to correspond substantially to a standard wheelchair height for improved stability. If the patient needs to go to the bathroom, the central portion 82 of the seat plate 80 is removed before placing the seat plate 80 under the patient, and the chair 10 is moved off the bed or moved upwards such as to be able to attach a bedpan under the seat plate 80. Alternately, the chair 10 can be wheeled and lowered over a regular toilet.

The chair 10 can also facilitate transfer of the patient to other types of seats, such as for example a car seat. In this case the seat assembly 22 is lowered until leveled with the car seat, the armrest 78 located between the patient and the car is pivoted upwardly out of the way, and the patient places his/her feet within the car and then slides directly on the car seat.

The chair 10 can assist the patient in a variety of activities, such as for example showering. Because of its compact design, and with the chair 10 made of appropriate water-resistant materials, the chair 10 can function as a wheel-in shower chair.

The lift assembly 44 allows a caretaker to use the chair 10 with patients having minimal mobility while minimizing the risk of injury to both the patient and the caretaker.

In a particular embodiment, the chair 10 can be disassembled, for example by detaching the seat assembly 22 from the swivel members 92, disengaging the table assembly 38 from the front post 34, and detaching the front post 34 and the footrest 84 from the base frame 12, and the seat assembly 22 can be collapsed by inclining the backrest 72 in contact with the seat plate 80, 80′ and rotating the armrests 78 in line with the backrest 72. As such, the disassembled chair 10 can be fitted in a relatively small enclosure such as a car trunk, and easily reassembled with a minimal number of or without tools.

The embodiments of the invention described above are intended to be exemplary. Those skilled in the art will therefore appreciate that the foregoing description is illustrative only, and that various alternate configurations and modifications can be devised without departing from the spirit of the present invention.

1. A chair for supporting a patient, the chair comprising:
a frame having a displaceable base and a seat support member;
a seat assembly for supporting a seated patient, the seat assembly having a seat portion including a removable seat plate and a backrest portion extending upwardly from the seat portion at a rear end thereof;
the seat assembly being removably and rotationally engaged to the seat support member of the frame by two laterally spaced apart side swivel members permitting the seat assembly to selectively pivot relative to the frame about a substantially vertical pivot axis located at each of the two side swivel members, the swivel members engaging opposed sides of a front end of the seat portion to corresponding mounting points on the frame; and
wherein each swivel member includes a protruding locking member normally positioned in a closed position by a biasing member such as to engage the seat assembly to the frame, the locking member of the two swivel members being collapsible under a force acting against that of the biasing member to displace the locking member into an open position such that the seat assembly is pivotable relative to the frame, wherein the seat assembly is pivotable about the substantially vertical pivot axis of one of the swivel members having the locking member in the closed position when the locking member of the other of the swivel members is disposed in the open position.

2. The chair as defined in claim 1, wherein the swivel members include a hollow member slidably receiving the locking member therein, the biasing member including a spring forcing the locking member to protrude from the hollow member, and the front end of the seat portion including a plate having a hole defined therethrough, the locking member being received in the hole of the respective plate for engaging the front end of the seat portion with the frame such that the locking member is in said closed position, and wherein the locking member is collapsible within the hollow member under the action of a force compressing the spring such that the plate and locking member are disengaged, such that the locking member is in said open position.

3. The chair as defined in claim 1, wherein a lift assembly is connected to the frame, the lift assembly including a belt for surrounding a torso of the patient, the belt being supported by a remainder of the lift assembly such as to be movable to lift a patient partially surrounded by the seat assembly sufficiently to one of engage and disengage the seat plate with the seat assembly.

4. The chair as defined in claim 3, wherein the lift assembly is connected to the frame in front of the seat assembly.

5. The chair as defined in claim 1, wherein a table assembly is connected to the frame and disposed in front of the seat assembly.

6. The chair as defined in claim 1, wherein the frame includes a central post having an adjustable length and extending upwardly from the base of the frame, such that a height of the seat assembly relative to the base is adjustable.

7. The chair as defined in claim 6, wherein the frame includes a transverse support member connected to a top of the central post, the transverse support member having the two spaced apart side swivel members disposed at opposite ends thereof.

8. The chair as defined in claim 1, wherein the base includes a plurality of wheels thereon for displacement of the chair.

9. The chair as defined in claim 1, wherein the seat assembly includes two spaced apart lateral members interconnected by a rear member, the backrest portion extending upwardly from the rear member, and an armrest extending from each side of the backrest portion.

10. The chair as defined in claim 8, wherein the seat plate is removably supported by at least the lateral members thereof.

11. A chair for supporting a patient, the chair comprising:
a frame having a displaceable base and a seat support member;
a seat assembly for supporting a seated patient, the seat assembly having a seat portion including a removable seat plate and a backrest portion extending upwardly from the seat portion at a rear end thereof;
the seat assembly being removably and rotationally engaged to the seat support member of the frame by two laterally spaced apart side swivel members, the swivel members pivotally engaging opposed sides of a front end of the seat portion to corresponding mounting points on the frame such that the seat assembly is selectively pivotable relative to the frame about a substantially vertical pivot axis located at each of the two side swivel members; and
wherein each said swivel member includes a locking mechanism displaceable between a locked position and an open position, the locking mechanism being biased in the locked position until manually actuated into the open position, the seat assembly being pivotable about the substantially vertical pivot axis of one of the two swivel members when the locking mechanism of said one of the two swivel members is disposed in the locked position and the other of the two swivel members is disposed in the open position.

12. The chair as defined in claim 11, wherein the locking mechanism of each said swivel member includes a protruding locking member normally maintained in a mated position with an aperture in a corresponding part by a biasing member, the locking member being collapsible under a force acting against that of the biasing member to displace the locking member, such that the locking mechanism is disposed in said open position allowing that the seat assembly to pivot relative to the frame.

13. The chair as defined in claim 12, wherein the swivel members include a hollow member slidably receiving the locking member therein, the biasing member including a spring forcing the locking member to protrude from the hollow member, and the front end of the seat portion including a plate having the aperture defined therethrough, the locking member being received in the aperture of the respective plate for engaging the front end of the seat portion with the frame such that the locking mechanism is in said locked position, and wherein the locking member is collapsible within the hollow member under the action of a force compressing the spring such that the plate and locking member are disengaged, thereby placing the locking mechanism is in said open position.

14. The chair as defined in claim 11, wherein a lift assembly is connected to the frame, the lift assembly including a belt for surrounding a torso of the patient, the belt being supported by a remainder of the lift assembly such as to be movable to lift a patient partially surrounded by the seat assembly sufficiently to one of engage and disengage the seat plate with the seat assembly.

15. The chair as defined in claim 14, wherein the lift assembly is connected to the frame in front of the seat assembly.

16. The chair as defined in claim 11, wherein a table assembly is connected to the frame and disposed in front of the seat assembly.

17. The chair as defined in claim 11, wherein the frame includes a central post having an adjustable length and extending upwardly from the base frame, such that a height of the seat assembly relative to the base of the frame is adjustable.

18. The chair as defined in claim 17, wherein the frame includes a transverse support member connected to a top of the central post, the transverse support member having the two spaced apart side swivel members disposed at opposite ends thereof.

19. The chair as defined in claim 11, wherein the base of the frame includes a plurality of wheels thereon for displacement of the chair.

20. The chair as defined in claim 11, wherein the seat assembly includes two spaced apart lateral members interconnected by a rear member, the backrest portion extending upwardly from the rear member, and an armrest extending from each side of the backrest portion.

21. The chair as defined in claim 20, wherein the seat plate is removably supported by at least the lateral members thereof.

22. A chair comprising a base frame including a plurality of wheels, a central post having an adjustable length and extending upwardly from the base frame closer to a front end than to a rear end thereof, a support member connected at a top of the central post, the support member including two spaced apart side swivel members, a table assembly connected to the base frame frontwardly of the central post, and a seat assembly for surrounding a patient together with the table assembly, the seat assembly including two spaced apart lateral members interconnected by a rear member, a backrest extending upwardly from the rear member, an armrest extending over each lateral member, and a removable seat plate removably supported by at least the lateral members, a front end of each of the lateral members removably and rotationally engaging a respective one of the swivel members, wherein each swivel member includes a hollow member slidably receiving therein a locking member, the locking member protruding from the cylindrical member under the action of a spring, and the front end of each lateral member including a plate having a hole defined therethrough, the locking member being received in the hole of the respective plate for engaging the front end of the lateral member with the swivel member, the locking member being collapsible within the hollow member under the action of a force compressing the spring such that the plate and locking member are disengaged, the seat assembly being rotatable about one of the swivel members engaged with the respective plate when the other of the swivel members is disengaged from the respective plate.

23. A chair for supporting a patient comprising:
a frame having a displaceable base and a seat support member;
a seat assembly for supporting the patient seated thereon, the seat assembly having a seat portion including a removable seat plate and a backrest portion extending upwardly from the seat portion at a rear end thereof, the seat assembly being removably and rotationally engaged to the seat support member of the frame by two laterally spaced apart side swivel members, the swivel members engaging opposed sides of a front end of the seat portion to corresponding mounting points on the seat support member of the frame, the swivel members permitting the seat assembly to selectively pivot relative to the frame about a substantially vertical pivot axis passing through each of the two side swivel members; and
a lift assembly connected to the frame in front of the seat assembly, the lift assembly including a belt for surrounding a torso of the patient, the belt being supported by a remainder of the lift assembly such as to be movable to lift a patient partially surrounded by the seat assembly sufficiently to engage the seat plate with at least the lateral members.

24. The chair as defined in claim 23, wherein each of said swivel member includes a locking mechanism displaceable between a locked position and an open position, the locking mechanism being biased in the locked position until manually actuated into the open position, the seat assembly being pivotable about the substantially vertical pivot axis of one of the two swivel members when the locking mechanism of said one of the two swivel members is disposed in the locked position and the other of the two swivel members is disposed in the open position.

25. The chair as defined in claim 24, wherein the locking mechanism of each said swivel member includes a protruding locking member normally maintained in a mated position with an aperture in a corresponding part by a biasing member, the locking member being collapsible under a force acting against that of the biasing member to displace the locking member, such that the locking mechanism is disposed in said open position allowing that the seat assembly to pivot relative to the frame.

26. The chair as defined in claim 25, wherein the swivel members include a hollow member slidably receiving the locking member therein, the biasing member including a spring forcing the locking member to protrude from the hollow member, and the front end of the seat portion including a plate having the aperture defined therethrough, the locking member being received in the aperture of the respective plate for engaging the front end of the seat portion with the frame such that the locking mechanism is in said locked position, and wherein the locking member is collapsible within the hollow member under the action of a force compressing the spring such that the plate and locking member are disengaged, thereby placing the locking mechanism is in said open position.
